(19) United States
(12) Patent Application Publication
(10) Pub. No.: US 2011/0251793 A1
(43) Pub. Date: Oct. 13, 2011

(54) ESTIMATION OF WIND MAGNITUDE AND DIRECTION

(75) Inventor: Anthony Calise, Collegeville, PA (US)

(73) Assignee: Atair Aerospace, Inc., Brooklyn, NY (US)

(21) Appl. No.: 13/028,544

(22) Filed: Feb. 16, 2011

Related U.S. Application Data
(60) Provisional application No. 61/304,985, filed on Feb. 16, 2010.

(51) Int. Cl. G06F 19/00

(52) U.S. Cl. 702/3

(57) ABSTRACT

The present invention relates to a method of providing a nearly continuously updated, on-line estimate of wind magnitude and direction when in turning flight and more particularly, relates to a method that requires only a GPS receiver and y- and z-body axis mounted gyros.

### CROSS-REFERENCE TO RELATED APPLICATIONS

This application claims priority from U.S. Provisional Patent Application No. 61/304,985 filed Feb. 16, 2010, entitled “Estimation Of Wind Magnitude And Direction” and incorporated fully herein by reference.

### TECHNICAL FIELD

The present invention relates to a method of providing a nearly continuously updated, on-line estimate of wind magnitude and direction when in turning flight and more particularly, relates to a method that requires only a GPS receiver and y- and z-body axis mounted gyros.

### BACKGROUND INFORMATION

When operating an air vehicle or any vehicle that moves through a fluid medium, in order to precisely control is inertial trajectory it is necessary to compensate the guidance commands for the effect of the winds and currents. While what is described in this invention can be applied to both powered and unpowered vehicles, such as aircraft and ships, the main concepts will be described in the context of estimating wind magnitude and direction for the purpose of autonomously guided, gliding parafoils. The main problem of estimating winds is illustrated in FIG. 1. In order to guide a vehicle relative to an inertial frame of reference (xᵢ,yᵢ) it is necessary to control its inertial velocity vector (\vec{V}ᵢ). In an aircraft this is typically done by deflecting aerodynamic surfaces such as elevator, ailerons or rudder. In a ship both propulsion and rudder deflections are commonly employed. In a guided parafoil, control lines are extended and retracted. Whatever the means of control that is employed, the vehicle responds to the control action by altering the magnitude and direction of its velocity relative to the fluid medium (\vec{V}ᵣₑₗ). Therefore \vec{V}ᵢ is only indirectly controlled by effecting changes in \vec{V}ᵣₑₗ. As shown in FIG. 1, the relationship between \vec{V}ᵢ and \vec{V}ᵣₑₗ depends on the wind speed and direction, represented by \vec{V}_{wind}. \vec{V}ᵢ is the vector sum of \vec{V}ᵣₑₗ and \vec{V}_{wind}

\vec{V}ᵢ=\vec{V}ᵣₑₗ+\vec{V}_{wind} (1)

This also reveals the fact that sensors on board the vehicle must provide the information needed to estimate both \vec{V}ᵢ and \vec{V}ᵣₑₗ in order to estimate \vec{V}_{wind}, since

\vec{V}_{wind}=\vec{V}ᵣₑₗ−\vec{V}ᵢ (2)

\vec{V}ᵢ is commonly obtained either from an inertial navigational aid or from direct measurements available from a GPS receiver.

Obtaining an estimate for \vec{V}ᵣₑₗ may entail the assumption that this vector is nearly aligned with the longitudinal body axis (x-body axis) in the case of a ship, or lies in the plane of symmetry (the x- and z-body plane) in the case of an aircraft. Then if the heading of the x-body is sensed (e.g. using a magnetometer) or is available from an inertial navigation system, and there is some means provided of measuring or estimating the speed relative to the fluid medium, then it is possible to form an estimate for \vec{V}ᵣₑₗ. If the angle of side slip can be large, as may be the case of vehicles capable of hear hovering flight, then a means of sensing this angle must also be provided.

The main concern in this invention pertains to providing a means of estimating \vec{V}_{wind} in situations where the body heading of the vehicles is not known, and there is no direct means of sensing the air speed. This is commonly encountered in low cost unmanned aerial vehicles that for practical reasons are not equipped with a magnetometer or a means of directly sensing air speed.

Of particular concern in this invention is estimating \vec{V}_{wind} for purposes of unmanned guided parafoil applications. In this case, it is shown in Ref. 1 that horizontal air speed (canopy speed) for any payload weight and altitude can be reliably estimated from knowing the horizontal air speed in level flight for a single reference weight and reference altitude. A similar method can be used for powered vehicles as well. Therefore it will be assumed here that the method of Ref. 1 is employed for estimating air speed, and the presentation will focus on the issue of not knowing the heading of the longitudinal (x-body) axis of the vehicle.

In the case of guided parafoils, a typical mission consists of flying to a target site and then depleting excess energy by executing a controlled spiral descent to the target altitude. At the end of this spiraling phase a final turn is executed to bring the air unit as close as possible to the target site, and aligned into the wind when flaring to a landing. The timing and duration of this final maneuver is critically dependent on knowing the wind magnitude a direction throughout the spiraling descent and final turn. Presently only a single estimate is obtained at the completion of each 360 degree turn. This estimate relies on the fact that \vec{V}ᵢ and \vec{V}ᵣₑₗ are approximately aligned at points on the spiral where the inertial speed reaches either a maximum or a minimum, and assumes that the wind magnitude and heading is constant in each spiral turn. The spiral radius and the timing of the final turn are adjusted in the guidance law based once-per-turn estimates of \vec{V}_{wind} that are obtained during the spiraling descent.

Experience has shown that there can be large changes in wind magnitude and direction that occur throughout the spiraling descent, and therefore terminal accuracy is presently limited by the lack of precise knowledge of wind conditions at each guidance update, which typically occurs every 0.25 seconds. Thus an on-line means of providing an accurate estimate of wind magnitude and direction at each guidance update is needed in order to order to achieve a significant reduction in terminal error. This is the heart of the problem that is addressed in the present invention.

### SUMMARY

The present invention features, in a first embodiment, a method of providing a nearly continuously updated, on-line estimate of wind magnitude and direction when in turning flight comprising the acts of: calculating a heading rate of a body frame using gyro outputs using a first equation: {circumflex over (\dot{ψ}=\sqrt{ω_{y}²+ω_{z}²}sign{ω_{z}), wherein ω_{y} and ω_{z} are the gyro outputs.

The method may further include the acts of: denoting points on a turn where GPS sensed inertial horizontal speed passes through a maximum (Vmax) point and a minimum (Vmin) point, wherein Vmax and Vmin are determined by comparing each sample of a GPS indicated horizontal speed with the last determined maximum and minimum value over a 360 degree turn and a change in the GPS indicated inertial heading between these points is denoted as δψᵢ.

In another embodiment, the method further includes the act of calculating the net bias error in {circumflex over (\dot{ψ} using the following equation: {circumflex over (\dot{ψ}_{bias}=(δψ_{b}−δψᵢ)/δt, wherein an integral body heading rate is denoted as δψ_{b}, and a time difference is denoted as δt.

In yet another embodiment, a method of estimating wind magnitude and direction comprises the acts of: completing a first turn; calculating an first estimate for a heading rate after completing the first turn using a first equation: {circumflex over (\dot{ψ}=\sqrt{ψ_{y}²+ω_{z}²}sign{ω_{z}); completing a second turn; and calculating a change in bias from the first turn to the second turn using a second equation: {circumflex over (\dot{ψ}_{bias}=(δψ_{b}−δψᵢ)/δt.

This embodiment may further comprise the act of calculating a wind speed and direction using the following equation:

Wspeed1=(V_{—}i_max−V_{—}i_min)/2

psi_{—}w1=psi_{—}i_max

This embodiment may further comprise the act of calculating a wind speed and direction using the following equation:

Wx=(Vi_north_max+Vi_north_min)/2

Wy=(Vi_east_max+Vi_east_min)/2;

Wspeed2=sqrt(Wx*Wx+Wy*Wy)

psiw2=a tan 2(Wy,Wx)

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 illustrates a relation between various velocity vectors;

FIG. 2 details body frame orientation during turning flight;

FIG. 3 is a simulated trajectory in a steady 8 m/s wind to the East;

FIG. 4 is a comparison of wind speed estimates in a steady 8 m/s wind to the East;

FIG. 5 is a comparison of wind heading estimates in a steady 8 m/s wind to the East;

FIG. 6a is a comparison of wind speed estimates in a 8 m/s wind with a 180 degree variation in wind heading;

FIG. 6b is a comparison of wind heading estimates in a 8 m/s wind with a 180 degree variation in wind heading;

FIG. 7 is a comparison of wind speed estimates in a 8 m/s wind with a 180 degree variation in wind heading and gyro errors;

FIG. 8a is a comparison of wind heading estimates in a 8 m/s wind with a 180 degree variation in wind heading and gyro errors.

FIG. 8b is a comparison of wind heading estimates in a 8 m/s wind with a 180 degree variation in wind heading.

FIG. 9 is a comparison of wind magnitude estimates with variations in both wind magnitude and direction; and

FIG. 10 is a comparison of wind heading estimates with variations in both wind magnitude and direction.

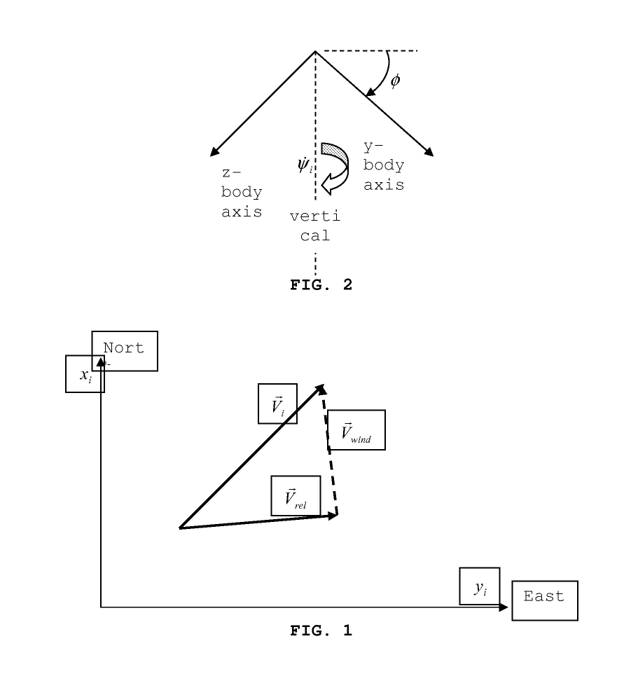

### DETAILED DESCRIPTION OF THE PREFERRED EMBODIMENTS

The present invention features, in a first embodiment shown in FIG. 2, the y- and z-axes of a body fixed coordinate frame when viewed looking down the longitudinal x-body axis in the direction of flight. These axes are shown in a banked orientation corresponding to the situation in which the air unit is turning in a right handed spiral. The bank angle is φ. The inertial heading rate of the body is about the vertical axis in this figure. It is assumed that the air unit is equipped with y- and z-body axis gyros that sense the angular rate about these axes, to within an unknown bias amount. In addition there is sensor noise and a sinusoidal like error primarily in the z-body axis gyro due to vibrations that occur in the suspension system.

An estimate for the heading rate of the body frame using gyro outputs can be formed using

{circumflex over (\dot{ψ}=\sqrt{ω_{y}²+ω_{z}²}sign{ω_{z}) (3)

where ω_{y} and ω_{z} are the gyro outputs, or suitably low pass filtered version of these signals. Low pass filtering is typically employed to reduce sensor noise and to avoid aliasing when sampling the gyro outputs. The method of estimating body heading requires that the estimate of body angular rate in Eq. (3) be integrated at a sufficiently high enough sample rate (typically 20 Hz or greater), and that this integral be corrected once per 360 degree turn by combining it with GPS data that is available at a lower sample rate (typically 4 Hz).

The integral of the gyro estimated body includes: Step-1: Denote the points on the turn where the GPS sensed inertial horizontal speed passes through a maximum and a minimum as the Vmax and Vmin points. These points can be determined by comparing each sample of the GPS indicated horizontal speed with the last determined maximum and minimum value over a 360 degree turn. At the Vmax and Vmin points \vec{V}ᵢ and \vec{V}ᵣₑₗ are nearly aligned. Let the change in the GPS indicated inertial heading between these points be denoted as δψᵢ. Likewise let the integral of body heading rate between these points be denoted as δψ_{b}, and let δt denote the time difference. Under ideal conditions of no sensor errors, δψᵢ and δψ_{b} should be equal. Ignoring the effect that random errors have on δψᵢ and δψ_{b}, we can attribute any difference found to be the result of the effect that gyro bias errors have on the computation in Eq. (1). Thus the net bias error in {circumflex over (\dot{ψ} can be estimated using heading rate is corrected in the following two step process:

{circumflex over (\dot{ψ}_{bias}=(δψ_{b}−δψᵢ)/δt (4)

This bias should be nearly constant from one turn to the next but the estimate can be updated at the end of every 360 degree turn. After completing the first turn, the first estimate of \dot{ψ}_{bias} is used to correct the estimate of body heading rate in Eq. (3), so that after completing the 2nd turn, Eq. (4) is used to estimate the change in the bias from the previous turn, which is then added to the last estimate of the bias, and used for the newly estimated bias in the next turn.

Step-2: The body heading obtained by integrating the estimated body angular rate will be off by a large amount at the completion of the first turn for two reasons: a) the initial heading is unknown when starting the integration process, and b) the estimated body angular rate obtained using Eq. (3) can have a large uncorrected bias which has not yet been estimated. Both of these effects are corrected by comparing the inertial heading (computed using the GPS data) with the body heading, either at the Vmax or Vmin point. It is best to select the point that is closest to the end of the current turn. The difference is the error due to the unknown initial heading plus the accumulated effect of bias error up to the selected Vmax or Vmin point in the turn. To this estimated error it is necessary to add the additional error due to the gyro bias that accumulates in the remainder of the 360 degree turn. This additional error is estimated by multiplying the bias estimated in Step-1 by the time difference from the Vmax or Vmin point, whichever is being used in this step, to the end of the turn. This provides a total correction for both the unknown initial heading and the error in {circumflex over (\dot{ψ} due to gyro biases. The total correction is applied to reset the estimated body heading at the end of the first turn.

After completing the above 2-step correction the entire process gets repeated for the next turn. The main difference will be that there are now reasonably good estimates for the initial heading and the bias in {circumflex over (\dot{ψ} at the start. So the correction for gyro bias and the heading reset that is applied at the end of the next turn will be relative to these estimates. The above description of the invention is summarized by the following algorithmic statements for realizing an on-line method of estimating wind magnitude and direction:

1. Initialize psi_o = 0, psi_dot = 0, gbias=0.
2. Calculate the estimated body heading rate in Eq. (3) using
the pre-filtered gyro outputs at the current time,
psi_dot_o = psi_dot;
psi_dot = sqrt(omegayf*omegayf+omegazf*omegazf)*sign(omegazf);
where omegayf and omegazf are the pre-filtered outputs of the y-
body and z-body gyros.
3. Numerically integrate Eq. (3). A preferred method is
psi = psi_o + (psi_dot_o+psi_dot)*dt/2 − gbias*dt;
psihat_o = psi;
where dt is the integration step size, typically no greater than
0.05 seconds.
4. Compute the current inertial heading and the horizontal
component of inertial speed using the North and East components
of GPS sensed velocity at each sample time where GPS data is
available (typically at 0.25 second intervals)
psi_i = atan2(Vi_east,Vi_north)
V_i = sqrt(Vi_east*Vi_east + Vi_north*Vi_north);
5. Store currently available values of time, psi and psi_i at
the Vmax and Vmin points on the current 360 degree turn. Denote
these values as t_max, t_min, psi_max, psi_min, psi_i_max, and
psi_i_min. The Vmax and Vmin points can only be determined to
within the GPS sample rate, since they are determined from
monitoring V_i over the 360 degree turn.
6. If the current time corresponds to the time for a guidance
update, estimate the wind heading in Eq. (2), using the estimate
of air speed obtained by employing the approach outlined in Ref.
1 and the current value of psi.
7. If the current 360 degree turn has not completed, return to
return to step 2, otherwise continue with step 8.
8. Estimate the bias in the value of psi_dot computed in step 2
using the values stored at the Vmax and Vmin points in the just
completed turn
dtime = t_max − t_min;
dpsi = psi_max − psi _min;
dpsi_i = psi_i_max − psi_i_min;
if dpsi_i*dpsi<0, dpsi_i=dpsi_i−2*pi*sign(dpsi_i); end
dgbias = (dpsi−dpsi_i)/(t_max − t_min);
gbias = gbias + dgbias;
9. Reset the current heading estimate (psi_o) using the values
stored at either the Vmax point or the Vmin point, whichever is
closest to the end of the just completed turn.
If t_max > t_min,
dpsi = psi − psi_max − dgbias*(time − t_max);
psi_o = psi_max + dpsi;
else
dpsi = psi − psi_min − dgbias*(time − t_min);
psi_o = psi_min + dpsi;
end
10. Return to step 2.

Several simulated examples are given in order to illustrate the level of accuracy attainable using the previously described method for estimating wind magnitude and direction. As previously explained, the current method provides a single estimate once per 360 degree turn. This method assumes that the wind magnitude and direction are constant over each 360 degree turn, and relies on the fact that at the Vmax and Vmin points \vec{V}ᵢ and \vec{V}ᵣₑₗ are approximately aligned. The wind speed and direction can be computed once-per-turn using either of the following methods:

### Once-Per-Turn Method-1

Wspeed1=(V_{—}i_max−V_{—}i_min)/2

psi_{—}w1=psi_{—}i_max

where V_i_max and psi_i_max are the values of V_i and psi_i computed in step 4 of the previous section, at the Vmax and Vmin points.

### Once-Per-Turn Method-2

Wx=(Vi_north_max+Vi_north_min)/2

Wy=(Vi_east_max+Vi_east_min)/2;

Wspeed2=sqrt(Wx*Wx+Wy*Wy)

psiw2=a tan 2(Wy,Wx)

where Vi_north_max and Vi_east_min are the GPS indicated North and East components of inertial velocity at the Vmax and Vmin points.

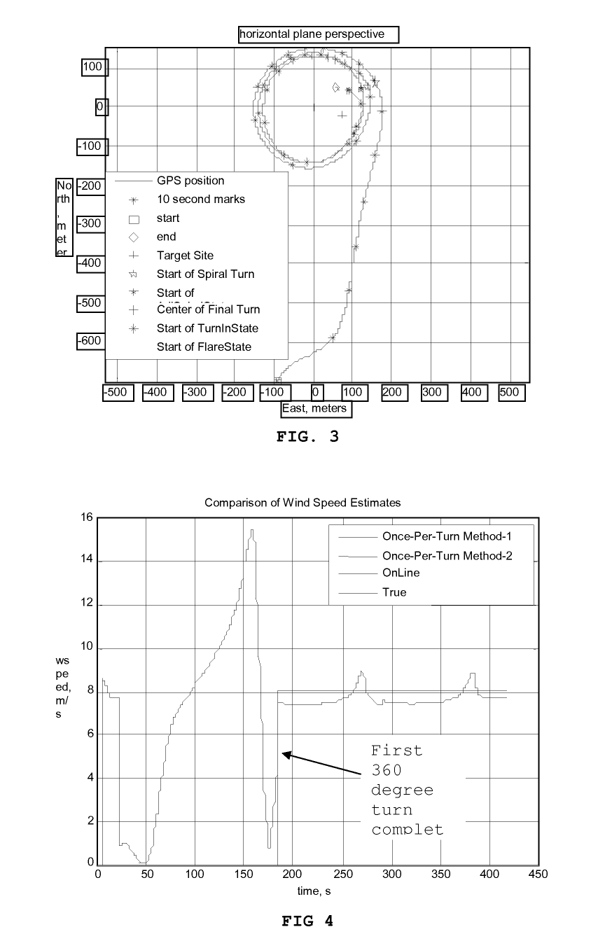

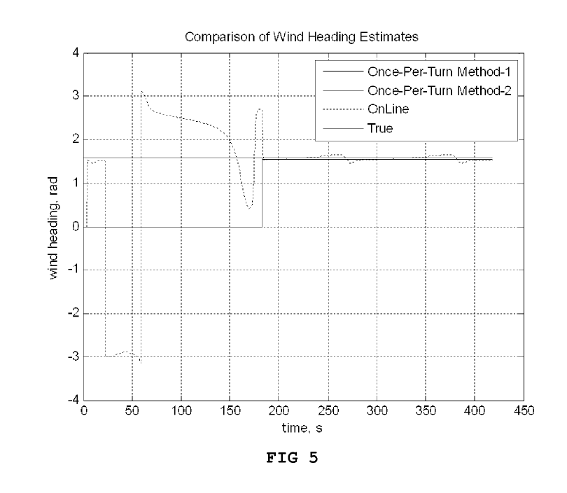

FIG. 3 shows the simulated trajectory in which the guidance law makes use of wind estimates obtained using the once-per-turn Method-1 described above. There are 3 completed 360 degree spiral turns. The corresponding estimates of wind magnitude and direction using all three methods (the two once-per-turn methods described above, and the on-line method described in the previous section) are compared with the true wind magnitude and direction in FIGS. 4 and 5. In this case the true wind magnitude is 8 meters/second, and the true wind heading is to East (wind heading=1.57 radians). In this example we are comparing these estimates for the ideal situation in which there are no sensor errors. Note that for this case the once-per-turn methods are more accurate than the on-line method because the once-per-turn methods are ideally suited for the constant wind case. The main source of error in the on-line method in this case is the estimate of air speed employed using the third method in Ref. 1. Also note that none of the methods are capable of providing a reasonable estimate prior to the completion of the first spiral turn.

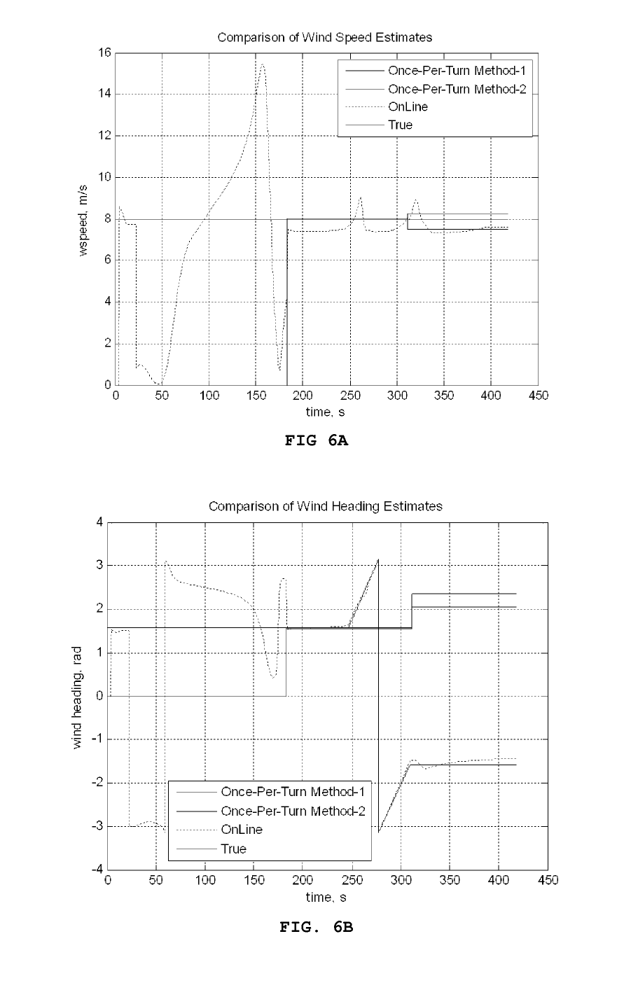

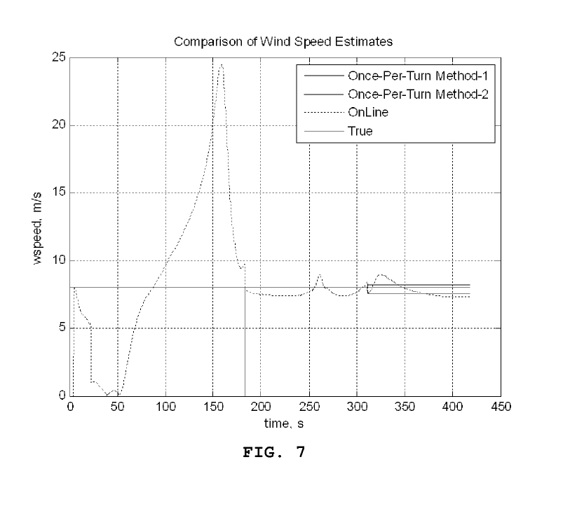

In a second embodiment, the effect of a 180 degree change in wind heading during the second spiral turn is illustrated. FIGS. 6a, 6b and 7 show the comparison of the wind magnitude and heading estimates for this case. Note that the performance of the once-per-turn methods is particularly poor in estimating wind direction in this case, whereas the on-line method provides a very reasonable estimate after the first 360 degree turn is completed.

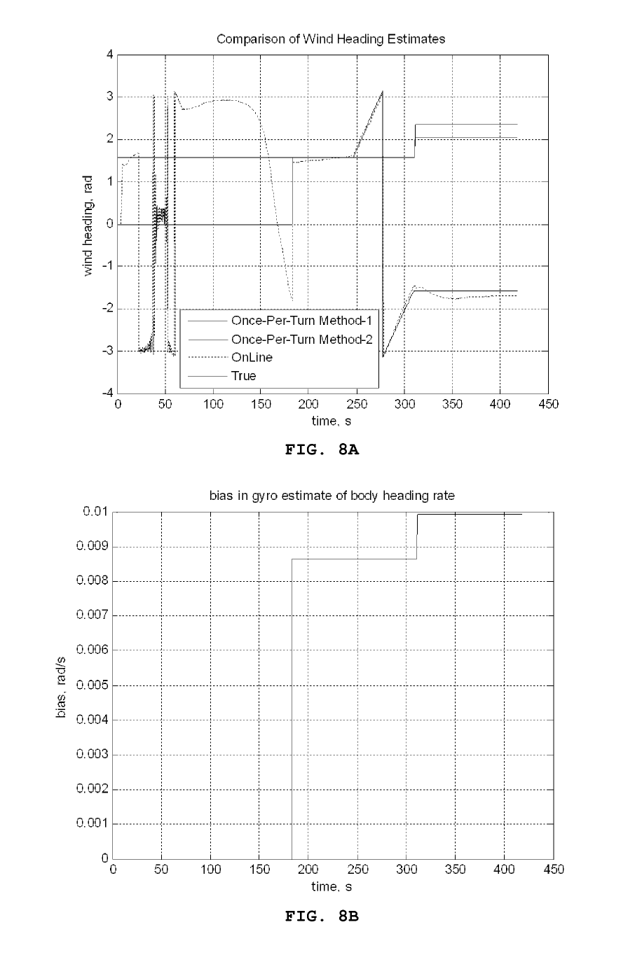

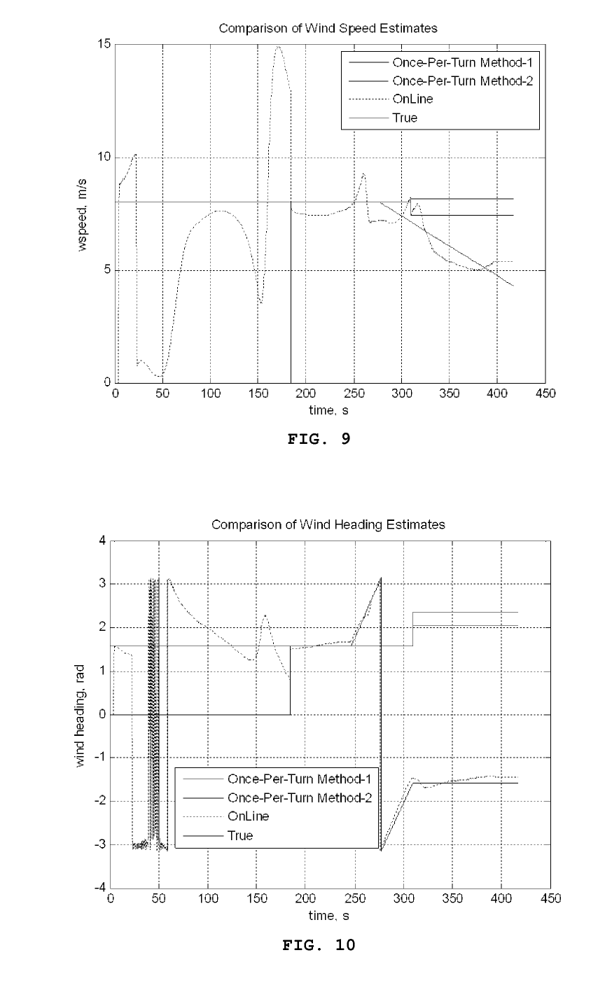

Another embodiment shows the effect that gyro errors have on the on-line method. The once-per-turn estimates are unaffected by the gyro errors since these estimates do not make use of the gyro outputs. The y- and z-body gyros are modeled as having a 0.01 radian/second bias error in the y-body gyro, a −0.01 radian/second bias error in the z-body gyro, and independent random errors with a standard deviation of 0.01 radian/second in both gyros In addition the z-body gyro error contains a sinusoidal error with a 0.05 radian/second amplitude and a frequency of oscillation of 2 Hertz. The resulting estimates are compared in FIGS. 7, 8a and 8b. These figures demonstrate that the on-line estimates are nearly insensitive to the modeled gyro errors. FIG. 9 shows the estimate of ‘gbias’ used in the integration of the body heading rate in Step 3 of the algorithm described in the previous section. This represents the on-line estimate of the bias present when using Eq. (3) to compute the body heading rate using the pre-filtered gyro outputs. A simple first order pre-filter was used, with a 10 radian/second bandwidth.

In another embodiment, the illustrated effect of changes in both wind speed and direction, using the same gyro error models employed in Example 3. The results are shown in FIGS. 9 and 10. Note that the once-per-turn methods are not capable of detecting the changes in wind speed and direction, whereas the on-line method provides a reasonable estimate throughout.

Modifications and substitutions by one of ordinary skill in the art are considered to be within the scope of the present invention, which is not to be limited except by the following claims.

The invention claimed is:

1. A method of providing a nearly continuously updated, on-line estimate of wind magnitude and direction when in turning flight comprising the acts of:
calculating a heading rate of a body frame using gyro outputs using a first equation: {circumflex over (\dot{ψ}=\sqrt{ω_{y}²+ω_{z}²}sign{ω_{z}), wherein ω_{y} and ω_{z} are the gyro outputs.

2. The method of claim 1, further including the acts of:
denoting points on a turn where GPS sensed inertial horizontal speed passes through a maximum (Vmax) point and a minimum (Vmin) point, wherein Vmax and Vmin are determined by comparing each sample of a GPS indicated horizontal speed with the last determined maximum and minimum value over a 360 degree turn and a change in the GPS indicated inertial heading between these points is denoted as δψᵢ.

3. The method of claim 2, further including the act of:
calculating the net bias error in {circumflex over (\dot{ψ} using the following equation: {circumflex over (\dot{ψ}_{bias}=(δψ_{b}−δψᵢ)/δt wherein an integral body heading rate is denoted as δψ_{b}, and a time difference is denoted as δt.

4. A method of estimating wind magnitude and direction comprising the acts of:
completing a first turn;
calculating an first estimate for a heading rate after completing the first turn using a first equation:
{circumflex over (\dot{ψ}=\sqrt{ω_{y}²+ω_{z}²}sign{ω_{z});
completing a second turn; and
calculating a change in bias from the first turn to the second turn using a second equation: {circumflex over (\dot{ψ}_{bias}=(δψ_{b}−δωᵢ)/δt.

5. The method of claim 4 further comprising the act of:
calculating a wind speed and direction using the following equation:
Wspeed1=(V_i_max−V_i_min)/2
psi_{—}w1=psi_{—}i_max

6. The method of claim 4 further comprising the act of:
calculating a wind speed and direction using the following equation:
Wx=(Vi_north_max+Vi_north_min)/2
Wy=(Vi_east_max+Vi_east_min)/2;
Wspeed2=sqrt(Wx*Wx+Wy*Wy)
psiw2=a tan 2(Wy,Wx)
